(19) United States
(12) Patent Application Publication
(10) Pub. No.: US 2009/0271770 A1
(43) Pub. Date: Oct. 29, 2009

(54) METHOD, SYSTEM, AND COMPUTER PROGRAM PRODUCT FOR GENERATING UNIT TESTING SCRIPTS

(75) Inventors: Yarden Nir-Buchbinder, Haifa (IL); Dan Pelleg, Haifa (IL); Orna Raz-Pelleg, Haifa (IL)

Correspondence Address: KEUSEY, TUTUNJIAN & BITETTO, P.C., 20 CROSSWAYS PARK NORTH, SUITE 210, WOODBURY, NY, 11797, US

(73) Assignee: INTERNATIONAL BUSINESS MACHINES CORPORATION, ARMONK, NY (US)

(21) Appl. No.: 12/110,401

(22) Filed: Apr. 28, 2008

(51) Int. Cl. G06F 9/45

(52) U.S. Cl. 717/136

(57) ABSTRACT

A method, system, and computer program product are provided for generating unit testing scripts. The method includes receiving programming code having a condition expressed therein, and transforming the code by wrapping the condition into a mock function. The mock function receives a Boolean argument as an input and provides a Boolean value as an output irrespective of a pre-transformed input and a pre-transformed output of the condition. The Boolean value is capable of selectively being the Boolean argument received as the input or a different value specified by a user. The method further includes receiving a user input specifying a behavior relating to how a return value is generated for the mock function. The Boolean value is provided in accordance with the specified behavior. At least one pre-transformation output of the condition prior to the transforming step is direct-function independent.

### BACKGROUND

1. Technical Field

The present invention relates to a method, a system, and a computer program product for generating unit testing scripts.

2. Description of the Related Art

Good software development methodology typically involves a unit test that checks all code paths. Some paths, including error-handling code paths as one particular example, are hard to reach at unit testing because such paths depend on rare conditions which are beyond the control of the test developer. For example, consider the following exemplary program code:

returnCode = diskWriter.performOperation( );
if (returnCode == HARDWARE_FAILURE) {
//code to handle disk failure
...
}

An approach used by some developers is to run the program in a debugger, set a breakpoint at the condition, and use the debugger controls to force the execution of the error-handling block, although the condition is actually false. The problem with this approach is that it is quite difficult to automate, which results in the test being typically performed on a one-time basis rather than going into a regression suite. While a solution has been proposed for helping to automate debugger scripts, the solution depends on the support a debugger has for batch mode execution. Further, the initial creation of the debugger script is completely manual.

Another approach involves mock objects, where the test replaces diskWriter with an artificial version of its class (for example, DiskWriter) which, in certain conditions, returns the error code without really attempting to write to the disk. The problem here is that existing tools for mock objects are object-oriented, and would not help in the case where the function is a simple (for example, C) non-object function, or the error condition does not directly depend on a function at all (but, for example, depends instead on some variable value or a combination of values). Furthermore, consider the scenario where the above code is followed by returncode=diskWriter.performAnotherOperation( ), and the test developer wishes to test the case where the first method call returns an error, but the second method call performs the normal operation and succeeds. The existing mock object tools cannot support the preceding scenario.

There is a need to provide efficient unit test script generation tools.

### SUMMARY

The shortcomings of the prior art are overcome and additional advantages are provided through the provision of a method, a system, and computer program product for generating unit test scripts.

According to an aspect of the present principles, there is provided a method for generating a unit test script. The method includes receiving programming code having a condition expressed therein, and transforming the code by wrapping the condition into a mock function. The mock function receives a Boolean argument as an input and provides a Boolean value as an output irrespective of a pre-transformed input and a pre-transformed output of the condition. The Boolean value is capable of selectively being the Boolean argument received as the input or a different value specified by a user. The method further includes receiving a user input specifying a behavior relating to how a return value is generated for the mock function. The Boolean value is provided in accordance with the specified behavior. At least one pre-transformation output of the condition prior to the transforming step is direct-function independent. The condition is transformed at least such that an expected and valid output of the condition is directly in-deterministic from a single input value while an expected and valid output of the mock function is directly deterministic from the single input value when considered at a same language and same state of development. The single input value is the Boolean argument.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 illustrates an exemplary system having unit test script generation capabilities, according to an embodiment of the present principles;

FIG. 2 illustrates another exemplary system having unit test script generation capabilities, according to an embodiment of the present principles; and

FIG. 3 illustrates an exemplary method for generating unit test script, according to an embodiment of the present principles.

### DETAILED DESCRIPTION OF PREFERRED EMBODIMENTS

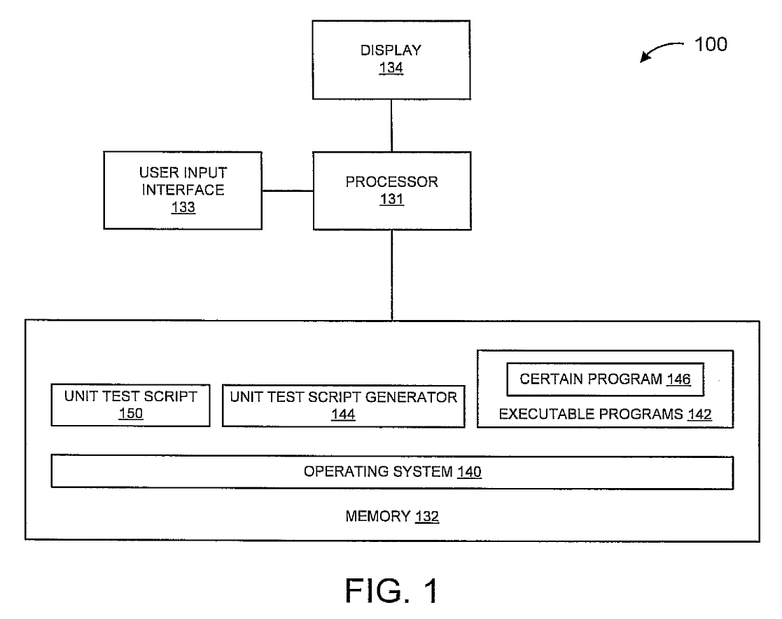

Referring now in detail to the figures in which like numerals represent the same or similar elements and initially to FIG. 1, an exemplary system having unit test script generation capabilities is indicated generally by the reference numeral 100.

System 100 may represent practically any type of computer, computer system or other programmable electronic system. System 100 may be connected to a network or may be a stand-alone system in the alternative.

System 100 includes a processor 131 that is connected to a memory unit 132, user input interface component 133 and display 134. System 100 can be connected to other devices via wired and/or wireless links. It is to be noted that system 100 can be characterized by a centralized architecture but that it can also be characterized by a distributed architecture. Accordingly, the various components of system 100 can be located near each other, but this is not necessarily so.

User input interface component 133 can be a keyboard, a mouse, a joystick, a touchpad, a microphone, a gesture recognition device, or a combination thereof. It is to be noted that, depending upon the embodiment, some of the above mentioned components may be optional.

According to a first embodiment of the invention, system 100 operates under the control of operating system 140, and executes various computer software applications, components, programs, objects, modules, and so forth, such as but not limited to executable programs 142, unit test software application 150 (also referred to as unit test script 150) and unit test script generator 144.

Conveniently, system 100 can be controlled by multiple operating systems that in turn are monitored by a hypervisor. For simplicity of explanation, FIG. 1 illustrates a single operating system.

It is noted that unit test script generator 144 can be viewed as one of the executable programs 142 and can be integrated within unit test script 150. It is further noted that system 100 can also execute a calling stack.

For simplicity of explanation it is assumed that unit test script 150 is used to test a certain program (such as 146) out of executable programs 142.

Unit test script 150 is capable of executing unit test scripts. It conveniently operates outside integrated development environments such as Eclipse.

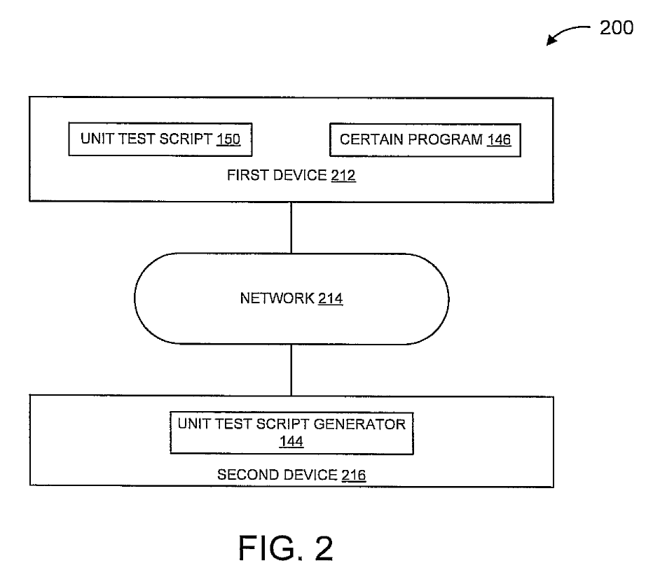

According to another embodiment of the invention, unit test script 150 and unit test script generator 144 are stored at different devices, as illustrated in FIG. 2. Referring to FIG. 2, another exemplary system having unit test script generation capabilities is indicated generally by the reference numeral 200. In system 200, first device 212 can send, over network 214, unit test script 150 (as well as certain program 146) to second device 216. Second device 216 can then execute unit test script generator 144 to generate unit test script that may be included in, and/or used by, the unit test script 150 when unit testing certain program 146. The results of the generation can be sent, over network, 214, to first device 212. Second device 216 can also amend unit test script 150 and send the amended unit test script 250 to first device 212. It is noted that first device 212 and second device 216 can include additional components such as a display, a user input interface, a processor, a memory and that they can store an operating system and executable programs.

Referring back to FIG. 1, unit test script generator 144 can be executed before an execution of unit test script 150. The execution of unit test script generator 144 can be triggered in response to a predefined unit test evaluation scheme (for example a periodical evaluation scheme), can be triggered in response to an occurrence of certain events (such as but not limited to an alteration of certain program 146), or can be triggered in view of a combination of both.

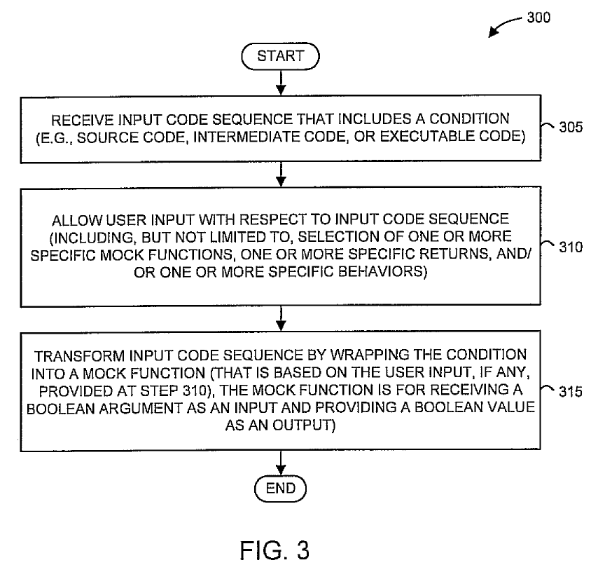

FIG. 3 is a flow chart of method 100 for generating a unit test script, according to an embodiment of the invention. The method 300 includes receiving an input code sequence (e.g., source code, intermediate code, or executable code) at step 305. The input code sequence includes at least one condition (hereinafter “condition”).

It is to be appreciated that while a condition is used with respect to step 305 and the following steps, the present principles are equally applicable to other structures in the input code sequence including, but not limited to, switch statements, and so forth.

At step 310, user input is allowed (to be received) with respect to the input code sequence. That is, the input code sequence may be evaluated to allow for user input that may include, for example, the selection of one or more specific mock functions, one or more specific returns (including, but not limited to, one or more specific return values), and/or one or more specific behaviors (relating to one or more specific mock functions and/or one or more specific returns), with respect to the conditions included in the input code sequence.

As an example of a user selection relating to step 310, in an embodiment, the user may select a particular behavior relating to how a return is calculated for a given mock function. For example, the calculation of the return may involve allowing the given mock function itself to (e.g., randomly) select a corresponding return value), thus imparting upon a random behavior on how the return is calculated. Moreover, the particular return value for a particular mock function may be selected by a user to be independent of an expected return value for the underlying condition to which the particular mock function pertains to (wraps around).

Moreover, the user input may be provided at step 310 using (in terms of) a special marking (or in terms of the expression content, or in terms of the function name the condition appears in, and so forth) that the tool (e.g., unit test generator 144) can read. The tool automatically takes care of setting the return based on the special marking.

User input may be further provided to execute any side effects necessary to make the system state consistent with the return, such as, turning on an external variable which is expected to be turned on if the function returns an error value.

At step 315, the input sequence is transformed by wrapping the condition into a mock function that receives a Boolean argument as an input to the mock function and provides a Boolean value as an output to the mock function. The Boolean value provided as the output of the mock function may be the input value to the mock function (i.e., the Boolean argument) or may be a different value specified by a user (e.g., the developer). Moreover, the input code sequence is transformed in consideration of any inputs provided by the user at step 310 relating to, for example, a selection of one or more mock functions, one or more returns, and/or one or more specific behaviors.

It should be understood that the elements shown in the FIGURES may be implemented in various forms of hardware, software or combinations thereof. Preferably, these elements are implemented in software on one or more appropriately programmed general-purpose digital computers having a processor and memory and input/output interfaces.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As used herein, the word “mock” and variations thereof (e.g., the word “mock” followed by a variable, etc.) is intended to represent a mock expression.

Further, as used herein, the phrase “wrapping”, when used, for example, to wrap a condition into a mock function, involves encapsulating and/or otherwise representing the condition with respect to the mock function in a manner that transforms the condition without actually replacing the condition. Thus, the expression of the mock function includes the underlying condition to which the mock function was applied, in contrast to a mock object applied to an object-oriented-programming object. The condition is transformed at least such that an expected and valid output of the condition is directly in-deterministic from a single input value, while an expected and valid output of the mock function is directly deterministic from a single input value, when considered at a same language and same state of development. The single input value of the mock function may be a Boolean argument, and the output of the mock function may be a Boolean value. The mock function allows for the condition to be fully tested while obviating the pitfalls associated with testing the condition in an efficient manner due to, for example, an expected and valid output of the condition being directly in-deterministic from a single input value.

Also, as used herein, the phrase “state of development” refers to any of, for example, source code, an intermediate version of the source code, and an executable version of the source code.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of the terms “and/or” and “at least one of”, for example, in the cases of “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

In an embodiment, the user specifies which conditions the user wants to affect. Our tool transforms the code, wrapping the expression in the condition with a new function: if (mock1(returncode==HARDWARE_FAILURE)); where mock1 is a function taking a Boolean argument and returning a Boolean value. Mock1 either returns its input value (to represent the natural behavior of the code) or, in conditions specified by the test developer, returns a value specified by the developer.

In an embodiment, the usage scenario is as follows: the test developer wants that for a given test, the condition in source foo.c line 24 should yield “false”. The test developer specifies this code location to the tool. The tool transforms the source code, using an existing instrumentation engine or a simple parsing, to produce the mock expression as in the previous section. The tool may also produce this implementation:

```
int mock1Return = ARG; //global variable, can also
take values FALSE and TRUE
      Boolean mock1(Boolean arg) {
            switch(mock1Return) {
                  case FALSE:
                        return false;
                  case TRUE:
                        return true;
                  Case ARG:
                        return arg;
      }
}
```

The test developer adds before the test mock1Return=FALSE and after the test mock1Return=ARG (optionally, to restore the default behavior). The test is compiled with the transformed code and the additional function, and the desired behavior is obtained.

Variations of, and enhancements to, the present principles are now described with respect to one or more embodiments of the present principles.

In an embodiment, the developer specifies special behavior for many conditions. The tool generates a different function for each condition (e.g., mock2, mock3, and so forth), and a different controlling variable respectively there for.

In an embodiment, the developer specifies, by a special marking in the test which the tool can read, the given condition should return false for this particular test. The tool automatically takes care of setting mock1Return.

In an embodiment, the instrumentation is done not by source transformation but by transformation of an executable representation or an intermediate representation (e.g., java bytecode).

In an embodiment, the developer specifies a more complex behavior pattern for the mock expression, e.g., “return true the first time the condition runs, false the third time, and behave naturally (return ‘arg’) the rest of the times”, or “return true randomly for a probability of 40%, false otherwise”. This can be done by the developer providing the implementation of mock1, or by specifying the behavior in some agreed syntax which the tool translates to the required code.

In an embodiment, the developer does not specify the behavior of the mock expression. Instead, mock1 randomly chooses the return value. This approach is useful if the test is expected to be tolerant to all behaviors, and enables easy coverage of all cases.

In an embodiment, the developer specifies affected conditions not in terms of explicit code location (which is unstable across code changes), but by special mark comments in the source which the tool can read, or in terms of the expression content, or in terms of the function name it appears in, or a combination thereof.

In an embodiment, user input may be further provided to execute any side effects necessary to make the system state consistent with the return, such as, turning on an external variable which is expected to be turned on if the function returns an error value.

In an embodiment, the handling is not constrained to only if statements. For example, conditionals in a loop can also be mocked, as well as switch statements. For the latter case (switch statements), the mock function takes an integer and returns an integer, where the developer specifies the desired value.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

1. A method for generating a unit test script, comprising:
receiving programming code having a condition expressed therein; and
transforming the code by wrapping the condition into a mock function, the mock function for receiving a Boolean argument as an input and for providing a Boolean value as an output irrespective of a pre-transformed input and a pre-transformed output of the condition, the Boolean value capable of selectively being the Boolean argument received as the input or a different value specified by a user,
wherein the method further comprises receiving a user input specifying a behavior relating to how a return value is generated for the mock function, and wherein the Boolean value is provided in accordance with the specified behavior, and wherein at least one pre-transformation output of the condition prior to said transforming step is direct-function independent, and
wherein the condition is transformed at least such that an expected and valid output of the condition is directly in-deterministic from a single input value while an expected and valid output of the mock function is directly deterministic from the single input value when considered at a same language and same state of development, the single input value being the Boolean argument.
